(19) United States
(12) Patent Application Publication
(10) Pub. No.: US 2021/0110967 A1
(43) Pub. Date: Apr. 15, 2021

(54) MAGNETIZING DEVICE

(71) Applicant: Chin-Ming HSIEH, HSINCHU CITY (TW)

(72) Inventor: Chin-Ming HSIEH, HSINCHU CITY (TW)

(21) Appl. No.: 16/599,101

(22) Filed: Oct. 10, 2019

(51) Int. Cl. H01F 27/34; H01F 13/00

(52) U.S. Cl. CPC H01F 27/346; H01F 13/00

(57) ABSTRACT

A magnetizing device includes: an inner magnetic portion having a first magnet assembly, a second magnet assembly, a third magnet assembly, and a fourth magnet assembly which are combined to form a hollow region. The first magnet assembly and the second magnet assembly each include: two first-direction magnets, a magnetic direction of each of the first-direction magnets is away from the hollow region, the third magnet assembly and the fourth magnet assembly each include two second-direction magnets, and a magnetic direction of each of the second-direction magnets faces the hollow region. A magnetic barrier portion surrounds the inner magnetic portion and includes a plurality of third-direction magnets, each two of the third-direction magnets has a joint surface therebetween, a magnetic direction of each third-direction magnet faces the joint surface, and magnetic poles of each of the third-direction magnets are opposite to magnetic poles of an adjacent third-direction magnet.

### BACKGROUND

### Field of the Invention

The present invention relates to a magnetizing device, and more particularly to a magnetizing device for magnetizing liquid.

### Related Prior Art

When various liquids pass through a magnetic field, the bonds between the liquid molecules will be broken by the magnetic field, causing the larger molecular group to be separated into a plurality of smaller molecular groups, thereby affecting the physical properties of the liquid. For example, when the cosmetic passes through the magnetic field, it will become a cosmetic of small molecules, which will greatly improve the effect of skin absorption. Similarly, if the magnetizing device is applied to gasoline or diesel, it can also make the oil molecules finer to increase the fluidity and combustion efficiency of the fuel and inhibit fungi reproduction.

The conventional fluid magnetizer is covered with a hollow tube which is provided for transporting liquid. However, the density of the magnetic lines of force of the fluid magnetizer overflowing outside the hollow tube is too high, and the density of the magnetic lines of force passing through the hollow tube is too low, as a result, the amount of magnetic flux leakage is too large, which is not good for the efficiency of liquid magnetization. For this reason, a magnetizing device having a low magnetic flux leakage rate and high magnetization efficiency is urgently required.

The present invention has arisen to mitigate and/or obviate the afore-described disadvantages.

### SUMMARY

One objective of the present invention is to provide a magnetizing device which has a low magnetic leakage and high liquid magnetization efficiency.

To achieve the above objective, a magnetizing device in accordance with one aspect of the present invention comprises:

an inner magnetic portion having at least four magnet assemblies, including a first magnet assembly, a second magnet assembly, a third magnet assembly, and a fourth magnet assembly, wherein the first magnet assembly, the second magnet assembly, the third magnet assembly and the fourth magnet assembly are combined to form a hollow region which is provided to accommodate a hollow tube; and a magnetic barrier portion surrounding the inner magnetic portion to prevent magnetic leakage of the inner magnetic portion;

wherein the first magnet assembly and the second magnet assembly each include: two first-direction magnets, a magnetic direction of each of the first-direction magnets is away from the hollow region, the third magnet assembly and the fourth magnet assembly each include two second-direction magnets, and a magnetic direction of each of the second-direction magnets faces the hollow region.

A magnetizing device in accordance with another aspect of the present invention comprises:

an inner magnetic portion having at least four magnet assemblies, including a first magnet assembly, a second magnet assembly, a third magnet assembly, and a fourth magnet assembly, wherein the first magnet assembly, the second magnet assembly, the third magnet assembly and the fourth magnet assembly are combined to form a hollow region which is provided to accommodate a hollow tube; and

a magnetic barrier portion surrounding the inner magnetic portion to prevent magnetic leakage of the inner magnetic portion.

As described above, the magnetic barrier portion surrounds the inner magnetic portion to effectively prevent the occurrence of magnetic leakage, and with the arrangement of the magnet assemblies of the inner magnetic portion, it can increase the magnetic field density in the hollow region, thus enhancing the liquid magnetization efficiency.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there are illustrated preferred embodiments of the invention.

### BRIEF DESCRIPTION OF THE DRAWINGS

FIG. 1 is a first embodiment of the magnetizing device of the present invention;

FIG. 2 is a magnetic gradient distribution of the first embodiment of the magnetizing device of the present invention;

FIG. 3 is a second embodiment of the magnetizing device of the present invention;

FIG. 4 is a magnetic gradient distribution of the second embodiment of the magnetizing device of the present invention;

FIG. 5 is a schematic view showing different embodiments of the magnetizing device of the present invention;

FIG. 6 is a schematic view showing different embodiments of the magnetizing device of the present invention;

FIG. 7 is a schematic view showing different embodiments of the magnetizing device of the present invention; and

FIG. 8 is a third embodiment of the magnetizing device of the present invention.

### DETAILED DESCRIPTION

The present invention will be clearer from the following description when viewed together with the accompanying drawings, which show, for purpose of illustrations only, the preferred embodiment in accordance with the present invention.

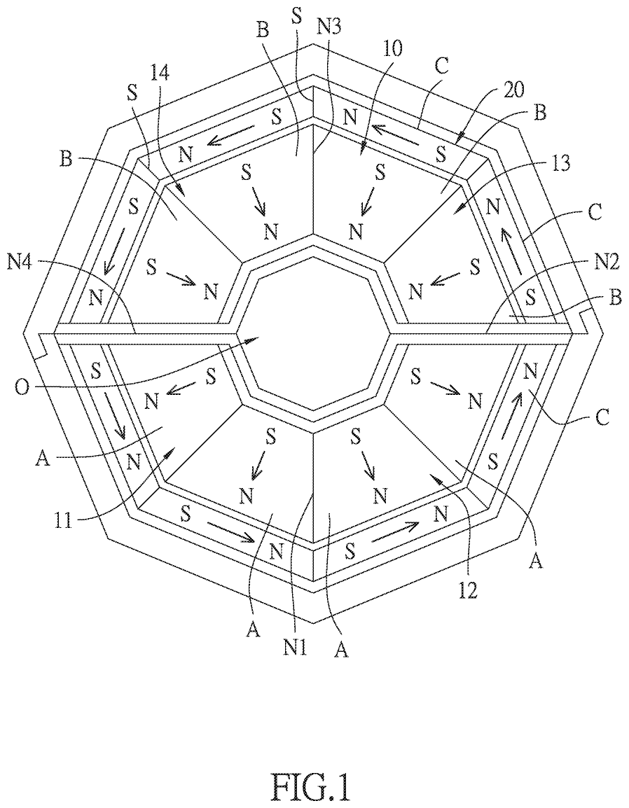

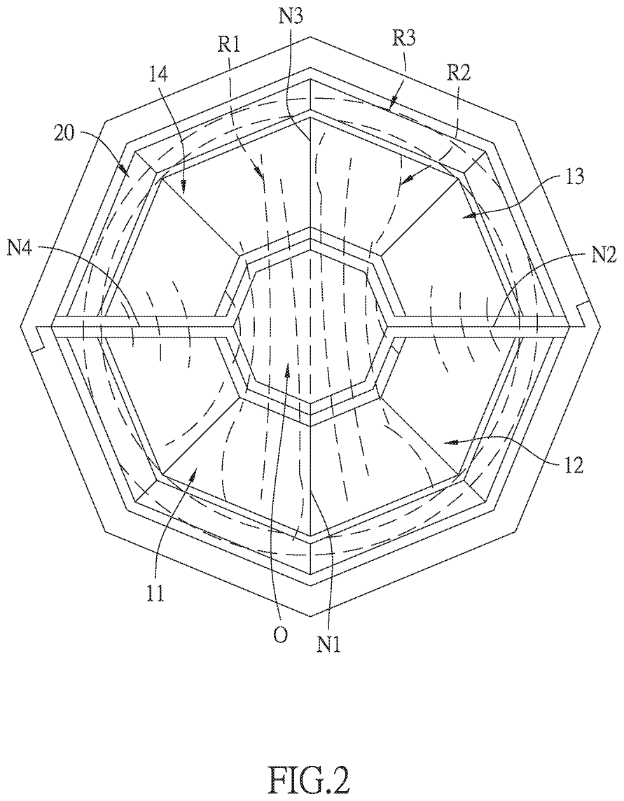

Referring to FIGS. 1-2, a magnetizing device in accordance with a first embodiment includes: an inner magnetic portion 10 and a magnetic barrier portion 20.

The inner magnetic portion 10 has at least four magnet assemblies, including a first magnet assembly 11, a second magnet assembly 12, a third magnet assembly 13, and a fourth magnet assembly 14, wherein the first magnet assembly 11, the second magnet assembly 12, the third magnet assembly 13 and the fourth magnet assembly 14 are combined to form a hollow region O which is provided to accommodate a hollow tube.

The first magnet assembly 11 and the second magnet assembly 12 each include: two first-direction magnets A, wherein the magnetic direction of each of the first-direction magnets A is away from the hollow region O. The third magnet assembly 13 and the fourth magnet assembly 14 each include two second-direction magnets B, and the magnetic direction of each of the second-direction magnets B faces the hollow region O.

In a specific embodiment, the first magnet assembly 11 and the second magnet assembly 12 have a first connecting surface N1 therebetween, the second magnet assembly 12 and the third magnet assembly 13 have a second connecting surface N2 therebetween, the third magnet assembly 13 and the fourth magnet assembly 14 have a third connecting surface N3 therebetween, and the fourth magnet assembly 14 and the first magnet assembly 11 have a fourth connecting surface N4 therebetween.

In the present embodiment, the inner magnetic portion 10 is octagonal.

In the Fig., the S indicated in the magnet represents the magnetic south pole, N represents the magnetic north pole, and the arrow indicates the magnetic direction from the south pole to the north pole.

The magnetic barrier portion 20 surrounds the inner magnetic portion 10 to block magnetic leakage of the inner magnetic portion 10.

Please refer to FIG. 2, which is a magnetic gradient distribution according to the first embodiment of the present invention, wherein the first magnet assembly 11 and the fourth magnet assembly 14 have a first magnetic circuit region R1 therebetween, the second magnet assembly 12 and the third magnet assembly 13 have a second magnetic circuit region R2 therebetween. The first magnetic circuit region R1 passes through the hollow region O and the fourth connecting surface N4, and the second magnetic circuit region R2 passes through the hollow region O and the second connecting surface N2. It can be seen that most of the magnetic lines of force in the first magnetic circuit region R1 and the second magnetic circuit region R2 pass through the hollow region O, and only a small portion of the magnetic lines of force pass through the second connecting surface N2 and the fourth connecting surface N4, which therefore greatly enhances the liquid magnetization effect.

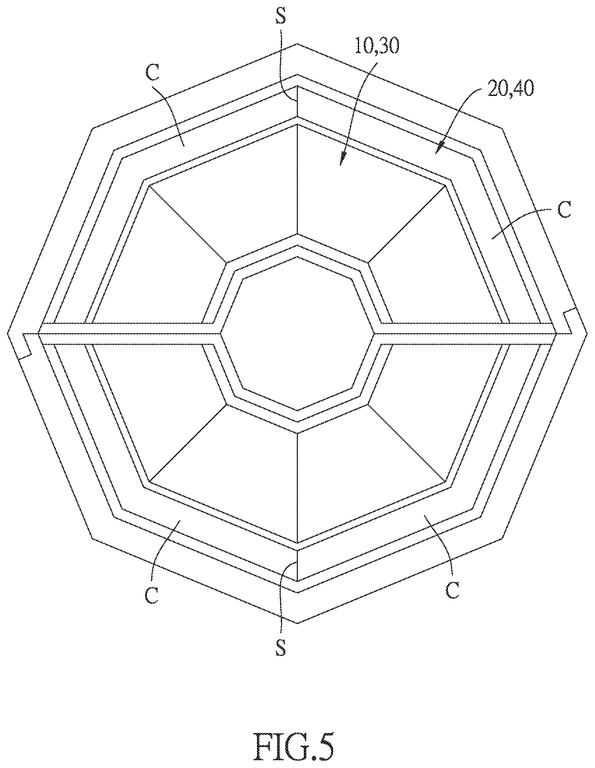

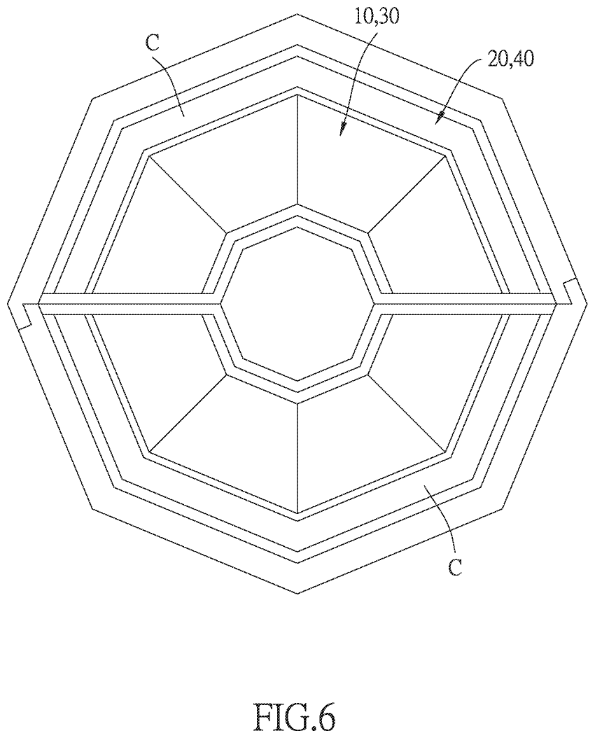

In one embodiment, referring to FIGS. 1, 5, and 6, the magnetic barrier portion 20 includes a plurality of third-direction magnets C, each two of the third-direction magnets C has a joint surface S therebetween, the magnetic direction of each of the third-direction magnets C faces the joint surface S, and the magnetic poles of each of the third-direction magnets C are opposite to the magnetic poles of an adjacent third-direction magnet C, that is, the south pole of each of the third-direction magnets C is adjacent to the north pole of the adjacent third-direction magnet C. The number of the third-direction magnets C of the magnetic barrier portions 20 may be two, four or eight, and each of the third-direction magnets C is disposed on a side of the first-direction magnets A and the second-direction magnets B away from the hollow region O.

In another embodiment, the magnetic barrier portion 20 is a magnet ring.

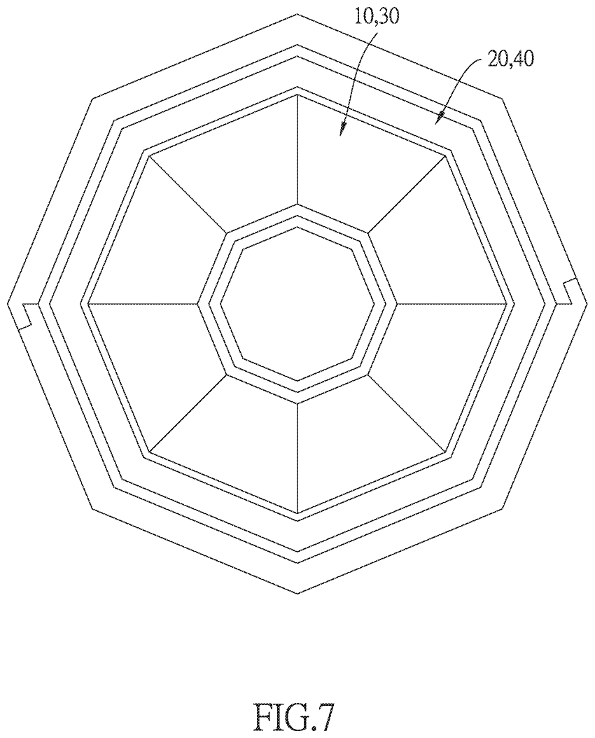

In another embodiment, the magnetic barrier portion 20 is made of at least one magnetic material capable of directly or indirectly generating magnetism. When the number of the magnetic material is one, as shown in FIG. 7, the magnetic material surrounds the inner magnetic portion 10 in a ring shape.

Further, the magnetic barrier portion 20 has a third magnetic circuit region R3, and the magnetic lines of force of the third magnetic circuit region R3 surround the inner magnetic portion 10 to form a closed magnetic circuit region, so as to effectively block the magnetic field of the first magnetic circuit region R1 from leaking out, thus reducing the magnetic flux leakage rate.

In the actual experiment, the higher the magnetic field in the center of the hollow region O of the magnetizing device, the lower the magnetic flux leakage rate, and the higher the density of the magnetic lines of force passing through the hollow region O. The magnetic field in the center of the hollow region O of the magnetizing device of the present invention is about 9700˜9800 Gauss, and the magnetic field in the center of the hollow region of the conventional magnetizing device without the magnetic barrier portion 20 is only about 6400˜6500 Gauss. The magnetic field of the magnetizing device of the present invention is higher than the prior art by 50.8%˜51.5%, which is sufficient to prove that the density of the magnetic lines of force of the magnetizing device of the present invention passing through the hollow region O is much higher than that of the conventional one.

In addition, in the actual experiment, the smaller the difference between the magnetic field in the center of the hollow region O of the magnetizing device and the magnetic field at the edge of the hollow region O, the lower the magnetic leakage of the magnetic field. The magnetic field in the center of the hollow region O of the magnetizing device of the present invention is about 9700˜9800 Gauss, the magnetic field close to the edge of the inner magnetic portion 10 is about 9900˜10000 Gauss, and the difference is about 200 Gauss. However, the magnetic field in the center of the hollow region of the conventional magnetizing device without the magnetic barrier portion is about 6400˜6500 Gauss, and the magnetic field close to the edge of the inner magnetic portion of the conventional magnetizing device without the magnetic barrier portion is about 7600˜7700 Gauss, the difference is about 1200 Gauss, which is enough to prove that the leakage of the magnetizing device of the present invention is much lower than that of conventional magnetizing device.

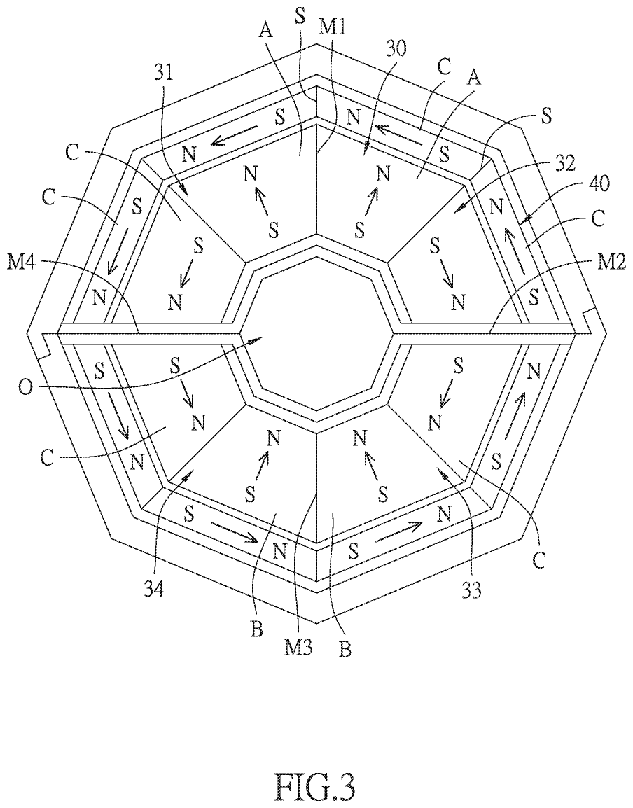

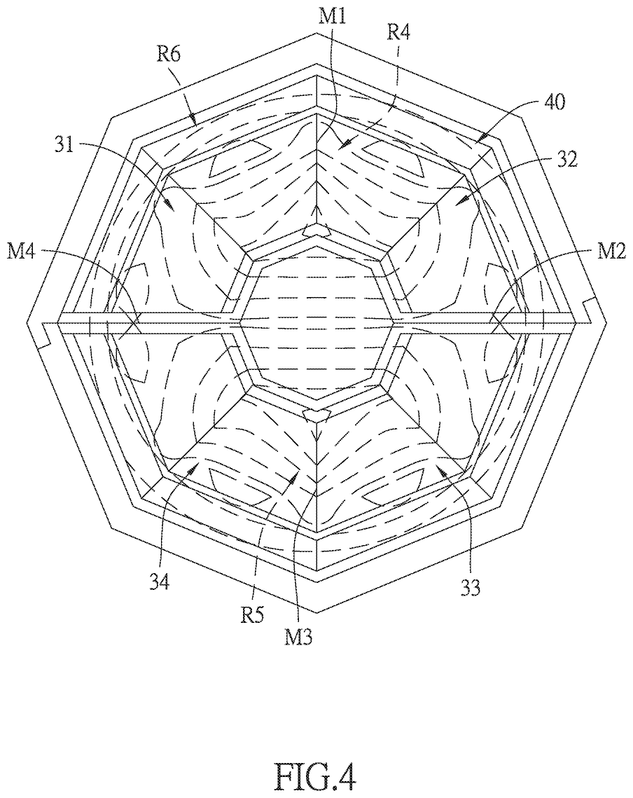

Referring to FIGS. 3 and 4, a magnetizing device in accordance with a second embodiment includes: an inner magnetic portion 30 and a magnetic barrier portion 40.

The inner magnetic portion 30 has at least four magnet assemblies, including a first magnet assembly 31, a second magnet assembly 32, a third magnet assembly 33, and a fourth magnet assembly 34, wherein the first magnet assembly 31, the second magnet assembly 32, the third magnet assembly 33 and the fourth magnet assembly 34 are combined to form a hollow region O which is provided to accommodate a hollow tube.

The first magnet assembly 31 and the second magnet assembly 32 have a first connecting surface M1 therebetween, the second magnet assembly 32 and the third magnet assembly 33 have a second connecting surface M2 therebetween, the third magnet assembly 33 and the fourth magnet assembly 34 have a third connecting surface M3 therebetween, and the fourth magnet assembly 34 and the first magnet assembly 31 have a fourth connecting surface M4 therebetween.

The first magnet assembly 31 and the second magnet assembly 32 each include a first-direction magnet A and a third-direction magnet C. The third magnet assembly 33 and the fourth magnet assembly 34 each include: a second-direction magnet B and a third-direction magnet C. The magnetic direction of the first-direction magnet A is away from the hollow region O, the magnetic direction of the second-direction magnet B is toward the hollow region O, and the magnetic direction of the third-direction magnet C is oriented toward or away from one of the connecting surfaces M1, M2, M3, and M4. The third-direction magnets C of the fourth magnet assembly 34 and the first magnet assembly 31 are adjacent to the fourth connecting surface M4 and opposite in magnetic polarity, and third-direction magnets C of the second magnet assembly 32 and the third magnet assembly 33 are adjacent to the second connecting surface M2 and opposite in magnetic polarity.

The magnetic barrier portion 40 surrounds the inner magnetic portion 30 to block magnetic leakage of the inner magnetic portion 30.

In one embodiment, referring to FIGS. 3, 5, and 6, the magnetic barrier portion 40 includes a plurality of third-direction magnets C, each two of the third-direction magnets C has a joint surface S therebetween, the magnetic direction of each of the third-direction magnets C faces the joint surface S, and the magnetic poles of each of the third-direction magnets C are opposite to the magnetic poles of an adjacent third-direction magnet C, that is, the south pole of each of the third-direction magnets C is adjacent to the north pole of the adjacent third-direction magnet C. The number of the third-direction magnets C of the magnetic barrier portions 20 may be two, four or eight, and each of the third-direction magnets C is disposed on a side of the first-direction magnets A and the second-direction magnets B away from the hollow region O.

In another embodiment, the magnetic barrier portion 40 is a magnet ring.

In another embodiment, the magnetic barrier portion 40 is made of at least one magnetic material capable of directly or indirectly generating magnetism. When the number of the magnetic material is one, as shown in FIG. 7, the magnetic material surrounds the inner magnetic portion 30 in a ring shape.

Please refer to FIG. 4, which is a magnetic gradient distribution according to the second embodiment of the present invention. Each of the magnet assemblies 31, 32, 33, 34 has a first magnetic circuit region R4 and a second magnetic circuit region R5. The first magnetic circuit region R4 passes through the first connecting surface M1, and the second magnetic circuit region R5 passes through the third connecting surface M3. The magnetic barrier portion 40 has a third magnetic circuit region R6, the magnetic lines of force of the third magnetic circuit region R6 surround the inner magnetic portion 30 to form a closed magnetic circuit, which can effectively block the magnetic field leakage of the first magnetic circuit region R4, thereby achieving the effect of low magnetic flux leakage.

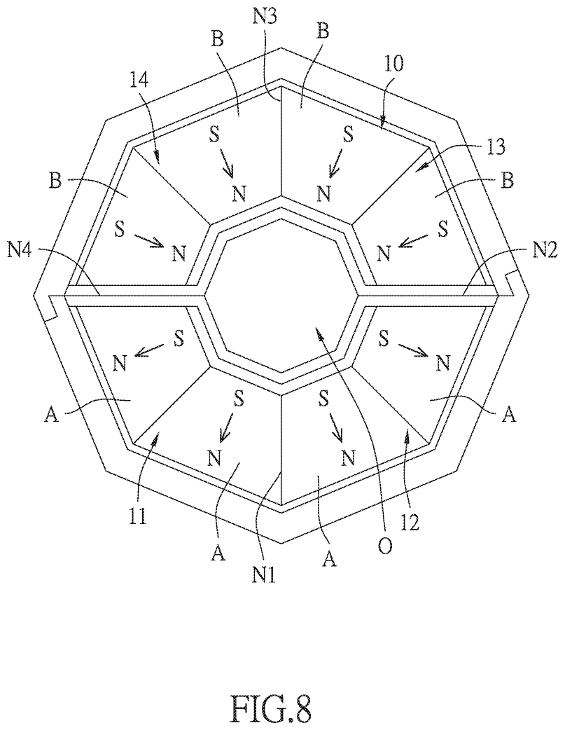

Referring to FIG. 8, a magnetizing device in accordance with a third embodiment includes an inner magnetic portion 10.

The inner magnetic portion 10 has at least four magnet assemblies, including a first magnet assembly 11, a second magnet assembly 12, a third magnet assembly 13, and a fourth magnet assembly 14, wherein the first magnet assembly 11, the second magnet assembly 12, the third magnet assembly 13 and the fourth magnet assembly 14 are combined to form a hollow region O which is provided to accommodate a hollow tube.

The first magnet assembly 11 and the second magnet assembly 12 each include: two first-direction magnets A, wherein the magnetic direction of each of the first-direction magnets A is away from the hollow region O. The third magnet assembly 13 and the fourth magnet assembly 14 each include two second-direction magnets B, and the magnetic direction of each of the second-direction magnets B faces the hollow region O.

In a specific embodiment, the first magnet assembly 11 and the second magnet assembly 12 have a first connecting surface N1 therebetween, the second magnet assembly 12 and the third magnet assembly 13 have a second connecting surface N2 therebetween, the third magnet assembly 13 and the fourth magnet assembly 14 have a third connecting surface N3 therebetween, and the fourth magnet assembly 14 and the first magnet assembly 11 have a fourth connecting surface N4 therebetween.

While we have shown and described various embodiments in accordance with the present invention, it is clear to those skilled in the art that further embodiments may be made without departing from the scope of the present invention.

What is claimed is:

1. A magnetizing device comprising:
an inner magnetic portion having at least four magnet assemblies, including a first magnet assembly, a second magnet assembly, a third magnet assembly, and a fourth magnet assembly, wherein the first magnet assembly, the second magnet assembly, the third magnet assembly and the fourth magnet assembly are combined to form a hollow region which is provided to accommodate a hollow tube; and
a magnetic barrier portion surrounding the inner magnetic portion to prevent magnetic leakage of the inner magnetic portion;
wherein the first magnet assembly and the second magnet assembly each include: two first-direction magnets, a magnetic direction of each of the first-direction magnets is away from the hollow region, the third magnet assembly and the fourth magnet assembly each include two second-direction magnets, and a magnetic direction of each of the second-direction magnets faces the hollow region.

2. The magnetizing device as claimed in claim 1, wherein the first magnet assembly is abutted against the second magnet assembly, the second magnet assembly is abutted against the third magnet assembly, the third magnet assembly is abutted against the fourth magnet assembly, and the fourth magnet assembly is abutted against the first magnet assembly.

3. The magnetizing device as claimed in claim 1, wherein the magnetic barrier portion includes a plurality of third-direction magnets, each two of the third-direction magnets has a joint surface therebetween, a magnetic direction of each of the third-direction magnets faces the joint surface, and magnetic poles of each of the third-direction magnets are opposite to magnetic poles of an adjacent third-direction magnet.

4. The magnetizing device as claimed in claim 3, wherein the magnetic barrier portions has two, four or eight said third-direction magnets, and each of the third-direction magnets is disposed on a side of the first-direction magnets and the second-direction magnets away from the hollow region.

5. The magnetizing device as claimed in claim 1, wherein the magnetic barrier portion is a magnet ring.

6. The magnetizing device as claimed in claim 1, wherein the magnetic barrier portion is made of at least one magnetic material.

7. The magnetizing device as claimed in claim 1, wherein the inner magnetic portion is octagonal.

8. A magnetizing device comprising:
an inner magnetic portion having at least four magnet assemblies, including a first magnet assembly, a second magnet assembly, a third magnet assembly, and a fourth magnet assembly, wherein the first magnet assembly, the second magnet assembly, the third magnet assembly and the fourth magnet assembly are combined to form a hollow region which is provided to accommodate a hollow tube; and
a magnetic barrier portion surrounding the inner magnetic portion to prevent magnetic leakage of the inner magnetic portion.

9. The magnetizing device as claimed in claim 8, wherein the magnetic barrier portion includes a plurality of third-direction magnets, each two of the third-direction magnets has a joint surface therebetween, a magnetic direction of each of the third-direction magnets faces the joint surface, and magnetic poles of each of the third-direction magnets are opposite to magnetic poles of an adjacent third-direction magnet.

10. The magnetizing device as claimed in claim 9, wherein the magnetic barrier portions has two, four or eight said third-direction magnets, and each of the third-direction magnets is disposed on a side of the first-direction magnets and the second-direction magnets away from the hollow region.

11. The magnetizing device as claimed in claim 8, wherein the magnetic barrier portion is a magnet ring.

12. The magnetizing device as claimed in claim 8, wherein the first magnet assembly and the second magnet assembly have a first connecting surface therebetween, the second magnet assembly and the third magnet assembly have a second connecting surface therebetween, the third magnet assembly and the fourth magnet assembly have a third connecting surface therebetween, and the fourth magnet assembly and the first magnet assembly have a fourth connecting surface therebetween.

13. The magnetizing device as claimed in claim 9, wherein the first magnet assembly and the second magnet assembly have a first connecting surface therebetween, the second magnet assembly and the third magnet assembly have a second connecting surface therebetween, the third magnet assembly and the fourth magnet assembly have a third connecting surface therebetween, and the fourth magnet assembly and the first magnet assembly have a fourth connecting surface therebetween.

14. The magnetizing device as claimed in claim 10, wherein the first magnet assembly and the second magnet assembly have a first connecting surface therebetween, the second magnet assembly and the third magnet assembly have a second connecting surface therebetween, the third magnet assembly and the fourth magnet assembly have a third connecting surface therebetween, and the fourth magnet assembly and the first magnet assembly have a fourth connecting surface therebetween.

15. The magnetizing device as claimed in claim 12, wherein the first magnet assembly and the second magnet assembly each include a first-direction magnet and a third-direction magnet, the third magnet assembly and the fourth magnet assembly each include a second-direction magnet and a third-direction magnet, a magnetic direction of the first-direction magnet is away from the hollow region, a magnetic direction of the second-direction magnet is toward the hollow region, a magnetic direction of the third-direction magnet is oriented toward or away from one of the connecting surfaces, the third-direction magnets of the fourth magnet assembly and the first magnet assembly are adjacent to the fourth connecting surface and opposite in magnetic polarity, and third-direction magnets of the second magnet assembly and the third magnet assembly are adjacent to the second connecting surface and opposite in magnetic polarity.

16. A magnetizing device comprising:
an inner magnetic portion having at least four magnet assemblies, including a first magnet assembly, a second magnet assembly, a third magnet assembly, and a fourth magnet assembly, wherein the first magnet assembly, the second magnet assembly, the third magnet assembly and the fourth magnet assembly are combined to form a hollow region which is provided to accommodate a hollow tube;
wherein the first magnet assembly and the second magnet assembly each include two first-direction magnets, a magnetic direction of each of the first-direction magnets is away from the hollow region, the third magnet assembly and the fourth magnet assembly each include two second-direction magnets, and a magnetic direction of each of the second-direction magnets faces the hollow region.

17. The magnetizing device as claimed in claim 16, wherein the first magnet assembly is abutted against the second magnet assembly, the second magnet assembly is abutted against the third magnet assembly, the third magnet assembly is abutted against the fourth magnet assembly, and the fourth magnet assembly is abutted against the first magnet assembly.
